(19) United States
(12) Patent Application Publication
(10) Pub. No.: US 2006/0034068 A1
(43) Pub. Date: Feb. 16, 2006

(54) Ceiling suction type screen and luminescence two-in-one structure

(76) Inventor: Chung-Wu Chia, Jhonghe City (TW)

Correspondence Address: Rightech Corporation, P.O. Box No. 6-57, Junghe, Taipei, 235, TW

(21) Appl. No.: 10/918,431

(22) Filed: Aug. 16, 2004

(51) Int. Cl. F21S 8/00

(52) U.S. Cl. 362/147

(57) ABSTRACT

A ceiling suction type screen and luminescence two-in-one structure connectors of a fluorescent lamp are connected to connector sockets of circuit boards, and the connector sockets are further connected to connectors of the ceiling suction type screen, and such connections thereby supply power to a fluorescent lamp. Microphones and control knobs are configured atop the circuit boards. During period of time the ceiling suction type screen is televising images and sound signals, the microphones receive the sound signals, which are transmitted through the circuit boards that thus control switching on and off of the fluorescent lamp, thereby achieving a dynamic state display feature that actualizes real-time transformation of on and off state of the fluorescent lamp and producing a strobe effect in sync with the sound signals.

### BACKGROUND OF THE INVENTION

(a) Field of the Invention

The present invention relates to a ceiling suction type screen and luminescence two-in-one structure having structural characteristics such that connectors of a fluorescent lamp are connected to connector sockets of circuit boards, and the connector sockets are further connected to connectors of the ceiling suction type screen, and such connections thereby supply power to a fluorescent lamp.

(b) Description of the Prior Art

A conventional ceiling suction type screen excludes any additional dynamic visual features, and necessarily relies on a stereo system visual device installed within a vehicle, including visual devices such as fluorescent lamps, and so on. However, price of such devices are relatively high, moreover, space arrangement within the vehicle must sometimes be modified in order to accommodate such devices, thereby a user is beset with increased exasperation when using the conventional ceiling suction type screen.

Hence, the inventor of the present invention expects to resolve and surmount existent technical difficulties in eliminating the aforementioned shortcomings.

### SUMMARY OF THE INVENTION

The present invention is to provide a ceiling suction type screen and luminescence two-in-one structure having structural characteristics such that connectors of a fluorescent lamp are connected to connector sockets of circuit boards, and the connector sockets are further connected to connectors of the ceiling suction type screen, and such connections thereby supply power to a fluorescent lamp. Upon completing the connections, and after the fluorescent lamp is disposed within the ceiling suction type screen, a light guide plate is placed on top. Microphones and control knobs are configured atop the circuit boards. During period of time the ceiling suction type screen is televising images and sound signals, the microphones receive the sound signals, which are transmitted through the circuit boards that thus control switching on and off of the fluorescent lamp, thereby achieving a dynamic state display feature that actualizes real-time transformation of on and off state of the fluorescent lamp and producing a strobe effect in sync with the sound signals. Adjustment in variation of time of strobe effect, on and off states of the fluorescent lamp and the dynamic state visual display effect of changing lamp colors are controlled through a controller.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows an elevational view according to the present invention.

FIG. 2 shows an exploded elevational view according to the present invention.

FIG. 3 shows a schematic view of an embodiment according to the present invention.

### DETAILED DESCRIPTION OF THE PREFERRED EMBODIMENTS

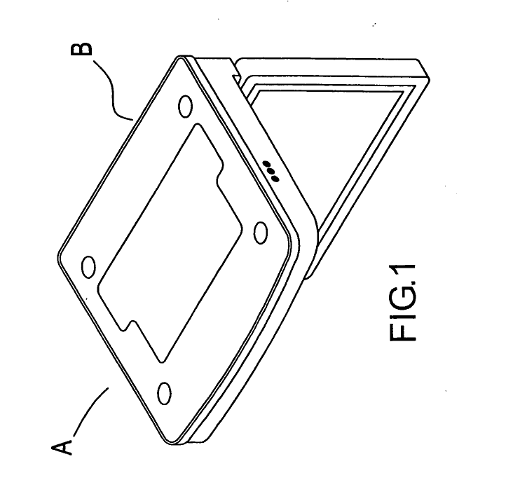

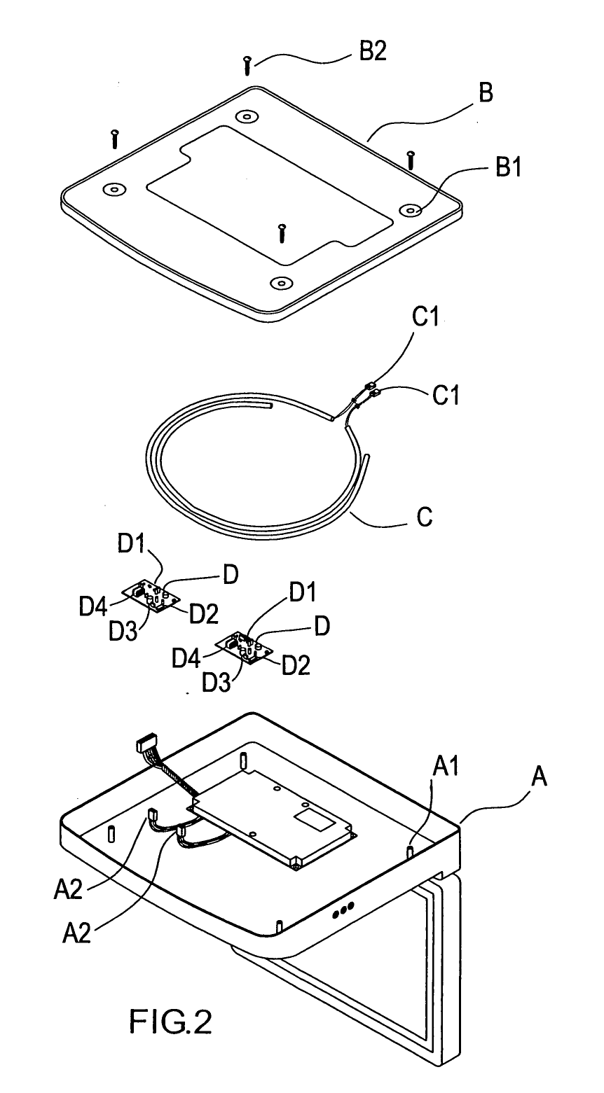

Referring to FIGS. 1 and 2, which show the present invention structured to comprise a ceiling suction type screen A, a light guide plate B, a fluorescent lamp C and circuit boards D. Structural characteristics of the present invention are such that connectors C1 of the fluorescent lamp C connect to connector sockets D1 of the circuit boards D. Connector sockets D2 connect to connectors A2 of the ceiling suction type screen A, and through such connections power is supplied to the fluorescent lamp C. Upon completing the connections, and after disposing the fluorescent lamp C within the ceiling suction type screen A, the light guide plate B is placed on top, and which is fastened down by means of screws B1 passing through screw holes B2, and thereon screwing down into screw holes A1.

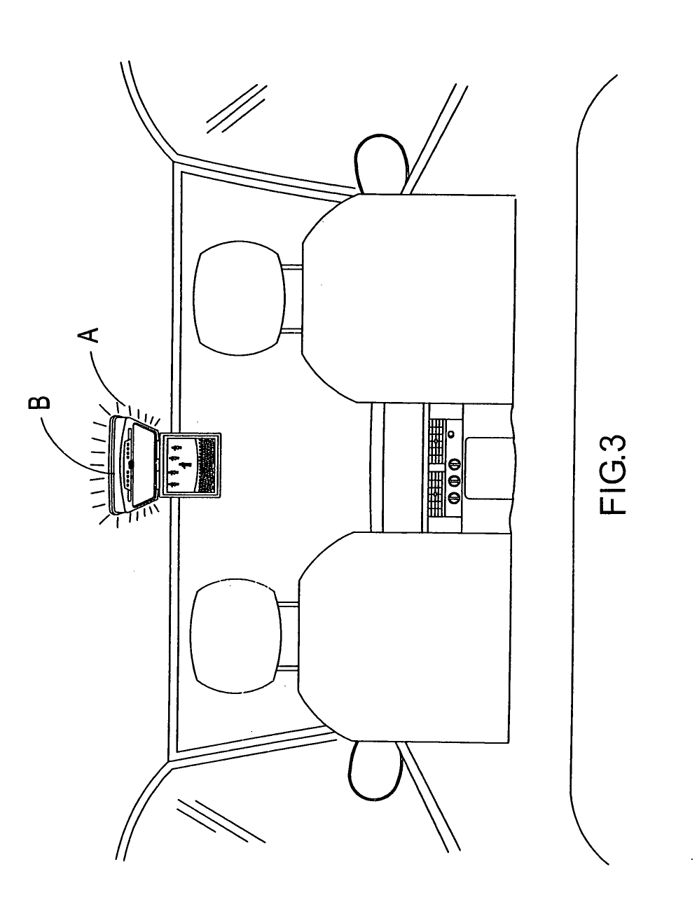

Microphones D3 and control knobs D4 are configured atop the circuit boards D. During period of time the ceiling suction type screen A is televising images and sound signals, the microphones D3 receive the sound signals, which are transmitted through the circuit boards D that thus control switching on and off of the fluorescent lamp C, thereby achieving a dynamic state display feature that actualizes real-time transformation of on and off state of the fluorescent lamp C and producing a strobe effect in sync with the sound signals. Adjustment in variation of time of strobe effect, on and off states of the fluorescent lamp and the dynamic state visual display effect of changing lamp colors are controlled through a controller. Referring to FIG. 3, after installing a ceiling suction type screen A within a vehicle, and upon televising sound and video signals within the vehicle, a strobe dynamic light effect is displayed within the vehicle through a light guide plate B, thereby reenforcing visual experience.

In order to better explicitly disclose advancement and practicability of the present invention, a comparative analysis with conventional art is described hereinafter:

Shortcomings of Conventional Art
1. Monotonous and lacking variability.
2. No visual effects.

Advantages of the Present Invention
1. Enhances usage efficacy of the ceiling suction type screen.
2. Reenforces visual effects during usage.
3. Provided with advancement and practicability.
4. Enhances commercial competitiveness.

In conclusion, the present invention in surmounting structural shortcomings of prior art has assuredly achieved effectiveness of anticipated advancement, and moreover, is easily understood by persons unfamiliar with related art. Furthermore, contents of the present invention have not been publicly disclosed prior to this application, and advancement and practicability of the present invention clearly comply with essential elements as required for application of a new patent model. Accordingly, a patent application is proposed herein.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A ceiling suction type screen and luminescence two-in-one structure comprising connectors of a fluorescent lamp connected to connector sockets of circuit boards, the connector sockets are further connected to connectors of the ceiling suction type screen, and such connections thereby supply power to a fluorescent lamp; upon completing the connections, and after the fluorescent lamp is disposed within the ceiling suction type screen, a light guide plate is placed on top; microphones and control knobs are configured atop the circuit boards, and during period of time the ceiling suction type screen is televising images and sound signals, the microphones receive the sound signals, which are transmitted through the circuit boards that thus control switching on and off of the fluorescent lamp, thereby achieving a dynamic state display feature that actualizes real-time transformation of on and off state of the fluorescent lamp and producing a strobe effect in sync with the sound signals; adjustment in variation of time of strobe effect, on and off states of the fluorescent lamp and the dynamic state visual display effect of changing lamp colors are controlled through a controller.
